(19) United States
(12) Patent Application Publication
(10) Pub. No.: US 2015/0221024 A1
(43) Pub. Date: Aug. 6, 2015

(54) DATA BIDDING SYSTEM AND METHOD

(71) Applicant: NIKET SIRSI, MENLO PARK, CA (US)

(72) Inventor: NIKET SIRSI, MENLO PARK, CA (US)

(21) Appl. No.: 14/615,297

(22) Filed: Feb. 5, 2015

Related U.S. Application Data
(60) Provisional application No. 61/936,079, filed on Feb. 5, 2014.

(51) Int. Cl. G06Q 30/08; H04L 29/08; G06F 17/30

(52) U.S. Cl. CPC G06Q 30/08; G06F 17/3053; H04L 67/02; H04L 67/10

(57) ABSTRACT

A method of exchanging personal browsing history information for value presented by a buyer. The present disclosure is for a method of managing personal data between a user's computer browsing history and an entity seeking this data and willing to pay for it. This exchange of data and value occurs with creation of a tracking data set containing user browsing information, in coordination with rating this information, offering the data up for bid, receiving bids, and then exchanging the data for value.

### PRIORITY/CROSS-REFERENCE TO RELATED APPLICATIONS

Claim to Priority: This Application claims priority to currently pending U.S. Patent Application No. 61/936079, which is herein incorporated by reference.

### TECHNICAL FIELD

The presently disclosed technology relates to exchange of cookies, referred to in this disclosure as tracking data sets, from websites to a user's computer, and more specifically, relates to a system and method by which a computer user can authorize a transfer of personally identifiable information (cookies) to web advertisers, and obtain payment for his personal information.

### BACKGROUND

Users of electronic devices, including computers, tablets and cell phones, routinely transmit personal data while surfing the internet or through other uses of the devices. Generally this is done by using locally stored data, presently called “cookies,” that gather personal data, such as browsing history, and transmit the personal data to a website the user is visiting or advertisement generation software embedded within the website. While the terms cookie and cookies are used herein, it should be known that other locally stored electronic data capable of performing similar function is foreseen. The term tracking data refers to the packet of information commonly called a “cookie”. This information is used for a variety of purposes; one specific example for use in targeted advertisements.

Targeted advertisements are very widespread due to their effectiveness. This type of advertising analyzes a user's personal data, including browsing history, and selects an advertisement to display based on a user's interests. For example, if a user has been looking at gps enabled sports watches, the advertisement will display gps enabled sports watches as well as retailers where the user can purchase the items. The data can further indicate a user's income level, political views, gender, geographic location, and many other valuable parameters that can be used for directing advertisements to the user. As another example, if you perform a google, ebay, or Amazon search for a product, such as a left handed guitar, ads for left handed guitars appear spontaneously when you open Facebook, a social media (not a merchandise selling) site.

A cookie, also known as an HTTP cookie, web cookie, Internet cookie, or browser cookie, is a small piece of data sent from a website and stored in a user's web browser while the user is browsing that website. Every time the user loads the website, the browser sends the cookie back to the server to notify the website of the user's previous activity. Cookies were designed to be a reliable mechanism for websites to remember stateful information (such as items in a shopping cart) or to record the user's browsing activity (including clicking particular buttons, logging in, or recording which pages were visited by the user as far back as months or years ago).

Although cookies cannot carry viruses, and cannot install malware on the host computer, tracking cookies and especially third-party tracking cookies are commonly used as ways to compile long-term records of individuals' browsing histories—a potential privacy concern that prompted European and U.S. law makers to take action in 2011. Cookies can also store passwords and form content a user has previously entered, such as a credit card number or an address. When a user accesses a website with a cookie function for the first time, a cookie is sent from server to the browser and stored with the browser in the local computer. Later when that user goes back to the same website, the website will recognize the user because of the stored cookie with the user's information.

Other kinds of cookies perform essential functions in the modern web. Perhaps most importantly, authentication cookies are the most common method used by web servers to know whether the user is logged in or not, and which account they are logged in with. Without such a mechanism, the site would not know whether to send a page containing sensitive information, or require the user to authenticate themselves by logging in. The security of an authentication cookie generally depends on the security of the issuing website and the user's web browser, and on whether the cookie data is encrypted. Security vulnerabilities may allow a cookie's data to be read by a hacker, used to gain access to user data, or used to gain access (with the user's credentials) to the website to which the cookie belongs (see cross-site scripting and cross-site request forgery for examples).

The current internet commerce model has cookies being placed on a user's computer with or without notification or permission, and the cookies gather personal browsing information to be sent to other sites. The data is analyzed for marketing use, and the referring website is paid a fee based on what advertisement is displayed and whether a user selects the advertisement. For example, if the user selects an advertisement displayed due to a prior search of gps enabled sports watches, the website where the advertisement was displayed is paid a fee. The user, whose data is being utilized, receives no compensation beyond, perhaps, an extra opportunity to find an item they have searched for.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

The disclosed inventive concepts relate to a system wherein a user controls what private data is shared with third parties as well as providing a mechanism for the user to obtain payment for sharing that personal information. A method is disclosed that includes a series of steps. While a specific order of steps is disclosed, it should be known that some of the disclosed steps can be performed in a different order without abandoning the inventive concepts disclosed herein.

The first step is intercepting incoming tracking data sets (cookies) and depositing them into an electronic “data aggregation module” (cookie jar). For purposes of explaining the disclosed technology, a cookie is defined as “personally identifiable information” or “tracking data” and a data aggregation module is an accumulation of information from a number of tracking data sets. Once inside the data aggregation module, individual tracking data sets can be sorted further into specific categories, such as advertising tracking data sets or user authentication tracking data sets. The second step is to create an “aggregated data set” also known as a “super cookie.” As used in this description, an “aggregated data set” can also be called an “aggregation of personal data”, and is made up of information from tracking data sets. The aggregated data set is an aggregate of all the data stored in the individual tracking data sets that are in the cookie data set jar. Each time the user receives a new tracking data, additional information is added to the aggregated data set.

The third step is the user selecting what data, if any, contained within the aggregated data set the user wishes to share when a tracking data request is received. While multiple methods can be used, a preferred embodiment places a selection menu under Settings in the user's chosen web browser, such as Chrome or Internet Explorer. As just one alternative, a specific data selection tool can be activated, allowing the user to select shared data in a separate interface.

The fourth step is calculating a Quality Score to the aggregated data set. While numerous methods can be used to create the Quality Score, a preferred embodiment will be presented. In the preferred embodiment the Quality Score will range between 0 and 100. A score of 0 indicates that the user has chosen not to share any information, so the aggregated data set has no intrinsic value to an advertiser. In contrast, a score of 100 indicates that all data collected from tracking data sets, including demographic and psychographic data, is available for advertisers and that a minimum number of tracking data sets have been collected.

The fifth step is intercepting tracking data requests. These are typically requests by a website for the personal data contained within a tracking data previously placed on the computer. The request can be for advertisement purposes, such as websites visited or purchases made, or can be for identification and login purposes. A sixth step is determining what type of data request has been received. If it is from the host website for identification purposes, the data request can be fulfilled if desired by the user. This can occur when a user visits a site, such as Amazon or the New York Times, and user information is used for identification purposes and automatically authenticates the user. Alternatively, if the data request is for advertisement purposes, such as data concerning browsing or shopping history, the method continues to the next step. The seventh step is to submit a “request for bid” to a bidding exchange server if the data request is for advertising purposes. The “request for bid” will include both the Quality Score as well as the type of information available.

In the eighth step, the bidding exchange server accepts bids for tracking data from ad exchange networks. In the ninth step, the bidding exchange server provides the winning bidder access to the user data that the user has elected to share. In the tenth step, payment is deposited into the user's linked account.

As shown above, the inventive concepts allow for a user to control what information is shared as well as receive payment for allowing advertisers to access that data. It is important to note that while certain embodiments have been given, these are for example purposes only and different embodiments are possible within the inventive concepts.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a flow chart showing the steps of the method of the disclosed technology.

FIG. 2 is a flow diagram showing a more detailed version of certain steps of the disclosed technology.

FIG. 3 is a flow diagram showing the steps of the method of the disclosed technology.

FIG. 4 is a flow diagram showing the steps of an embodiment of the disclosed technology.

FIG. 5 is a flow diagram showing the steps of an embodiment of the disclosed technology.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

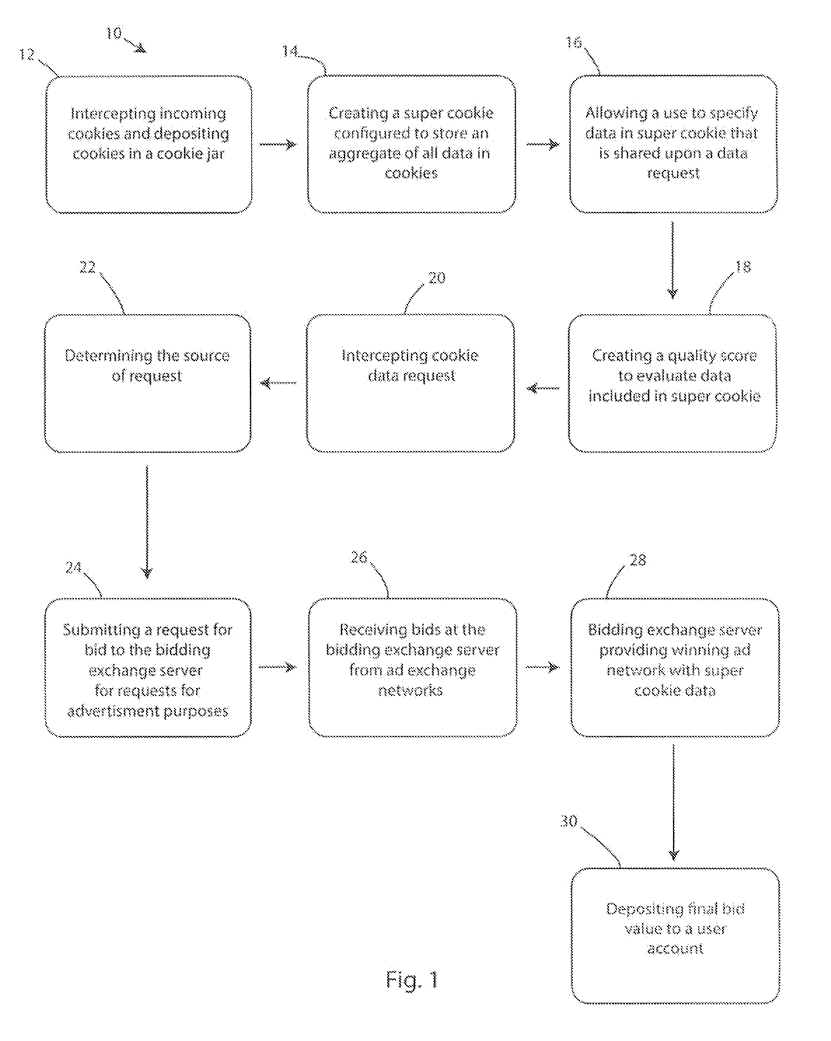

Shown in FIG. 1 is a flow diagram of the disclosed data bidder system 10. Shown at step 12 is the first step, which involves intercepting incoming tracking data sets and depositing the tracking data sets in a data aggregation module. This step is designated 12. In this context an incoming tracking data is a request to assemble a packet of personally identifiable information, and a data aggregation module is a collection of such tracking data sets. An aggregated data set is an aggregation of personal data from a number of tracking data sets. The tracking data is sent from a website and is received at the user's computer. In current technology the tracking data is unauthorized and unknown to the user, and the data it accumulates is sent to the tracking data's sender without permission by the user, and without payment to the user, even though it has commercial value.

The next step is shown as step 14, which is the step of creating an aggregated data set in which all data of other tracking data sets is aggregated.

Shown at step 16 is the third step, which is the step of allowing a user to specify data in the aggregated data set that is authorized to be shared upon a data request from a website. Data requests from a website occur when the sender of the tracking data requests that the user information in the tracking data to be sent.

Shown at step 18 is the step of creating a quality score for the aggregated data set. In the preferred embodiment the Quality Score will range between 0 and 100. A score of 0 indicates that the user has chosen not to share any information, so the aggregated data set has no intrinsic value to an advertiser. In contrast, a score of 100 indicates that all data collected from tracking data sets, including demographic and psychographic data, is available for advertisers and that a minimum number of tracking data sets have been collected. A further factor in the Quality Score can be a match between the buyer's desired demographics, and the users match to those demographics. For instance the buyer may want information from users in a high income bracket, or those who buy high priced items like watches and jewelry. If the tracking data contains a good match the buyer's preferred demographics, the Quality Score of the user's information would get a high rating

Step 20 shows the step of intercepting tracking data requests. In this context, tracking data requests are requests by a website for the personal data contained within a tracking data previously placed on the computer. The request can be for advertisement purposes, such as websites visited or purchases made, or can be for identification and login purposes.

Step 22 shows the step of determining the source of the tracking data request. In this context, the source of the tracking data request could be a web site requesting information from a previously deposited tracking data. Also, the type of data requested is evaluated. If the request is from the host website for identification purposes, the data request can be fulfilled if desired by the user. This can occur when a user visits a site, such as Amazon or the New York Times, and user information is used for identification purposes and automatically authenticates the user. Alternatively, if the data request is for advertisement purposes, such as data concerning browsing or shopping history, the method continues to the next step . . . , . . . , or . . . .

At box 24, the step of submitting a request for a bid occurs. The request is sent to a bidding exchange server which is like an auction house for connecting personal user information in tracking data sets to potential buyers of that information. The “request for bid” will include both the Quality Score as well as the type of information available.

Box 26 shows the step of receiving bids at the bidding exchange server from ad exchange networks.

The box at 28 shows the step of the bidding exchange server providing the winning ad network with the selected aggregated data set data of the user, in exchange for an amount bid, which is shown at box 30 of FIG. 1.

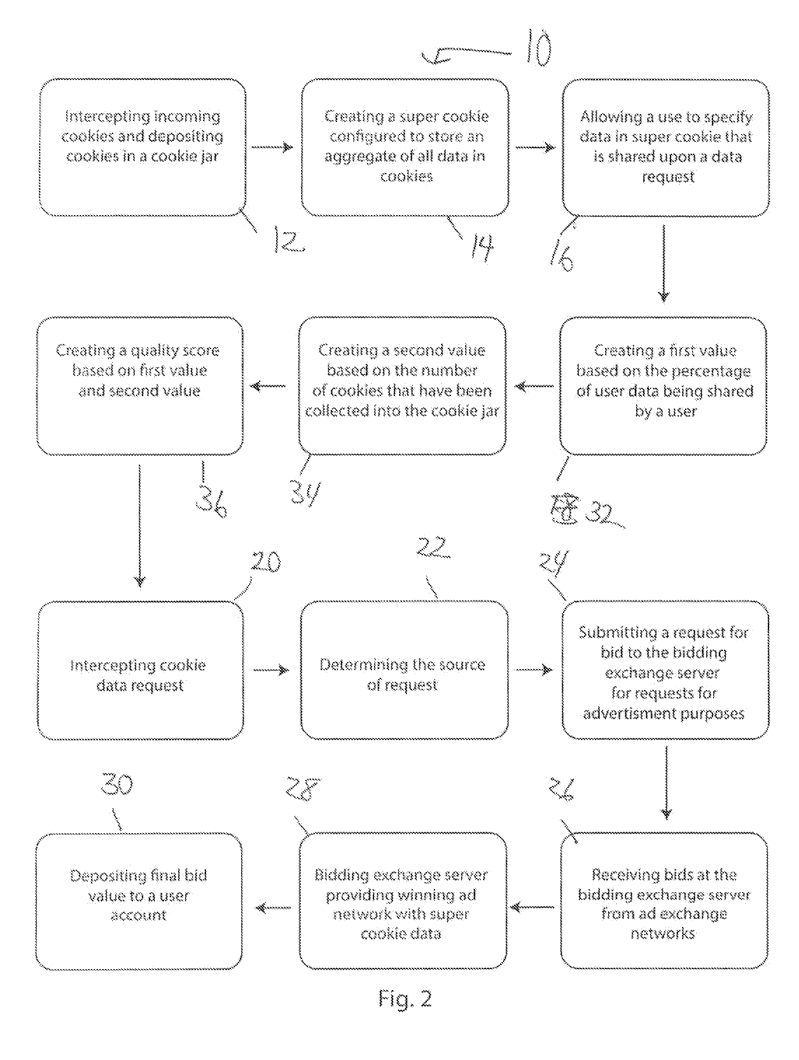

Shown in FIG. 2 is a flow diagram of an embodiment of the claimed data bidder system 10. FIG. 2 has many of the same steps as FIG. 1, such as

First step 12, intercepting incoming tracking data sets and depositing the tracking data sets in a data aggregation module.

Step 14, which is the step of creating a aggregated data set in which all data of other tracking data sets is aggregated.

Step 16, which is the step of allowing a user to specify data in the aggregated data set that is authorized to be shared upon a data request from a website.

The step 18 shown in FIG. 1 is expanded in FIG. 2 into step 32, in which a first value is created based on the percentage of the user data is allowed to be shared by the user. Step 34 is the step of creating a second value based on the number of cookies that have been collected. Step 36 is the step of creating a quality score based on the previously created first value and second value.

After step 36, the method shown in FIG. 2 proceeds to the same step which is shown in FIG. 1, which is Step 20. Step 20 shows the step of intercepting tracking data requests. In this context, tracking data requests are requests by a website for the personal data contained within a tracking data previously placed on the computer. The request can be for advertisement purposes, such as websites visited or purchases made, or can be for identification and login purposes.

FIG. 2 moves from Step 20 to Step 22, and shows the step of determining the source of the tracking data request. In this context, the source of the tracking data request could be a web site requesting information from a previously deposited tracking data. Also, the type of data requested is evaluated. If the request is from the host website for identification purposes, the data request can be fulfilled if desired by the user. This can occur when a user visits a site, such as Amazon or the New York Times, and user information is used for identification purposes and automatically authenticates the user. Alternatively, if the data request is for advertisement purposes, such as data concerning browsing or shopping history, the method continues to the next step.

At box 24 of FIG. 2, the step of submitting a request for a bid occurs. The request is sent to a bidding exchange server which is like an auction house for connecting personal user information in tracking data sets to potential buyers of that information. The “request for bid” will include both the Quality Score as well as the type of information available.

Box 26 of FIG. 2 shows the step of receiving bids at the bidding exchange server from ad exchange networks.

The box at 28 of FIG. 2 shows the step of the bidding exchange server providing the winning ad network with the selected aggregated data set data of the user, in exchange for an amount bid, which is shown at box 30 of FIG. 2.

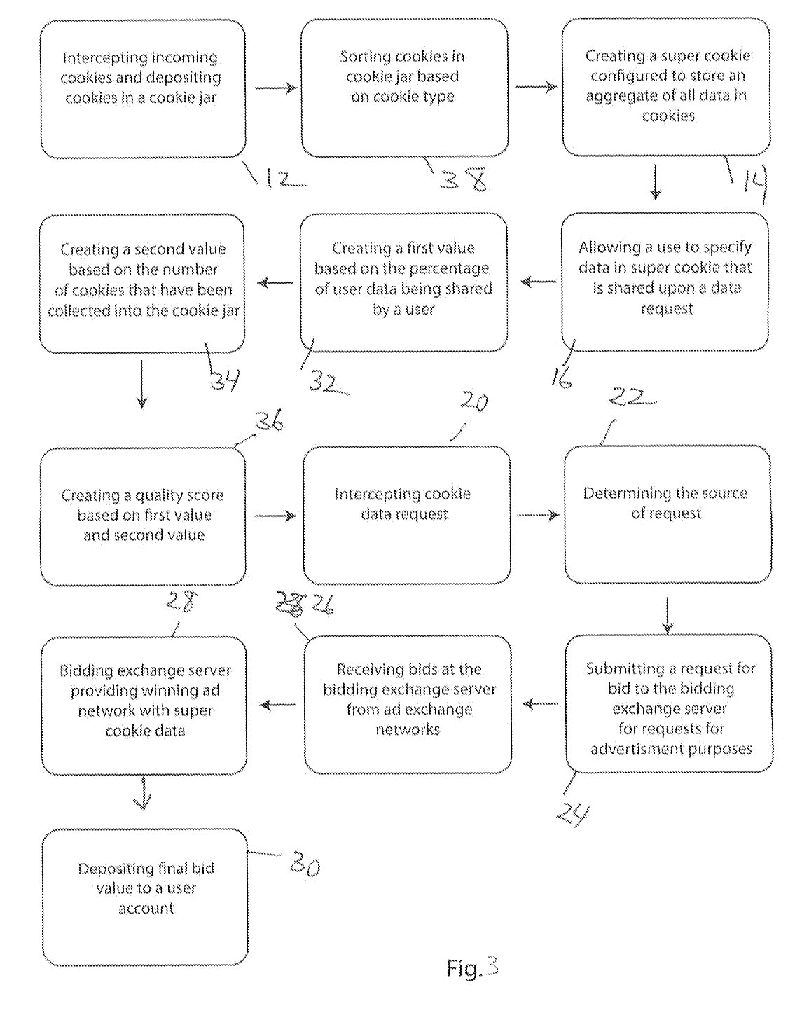

FIG. 3 shows a similar method as shown in FIGS. 1 and 2, with the additional step of Step 38, sorting cookies (tracking data sets) based in the cookie jar (data aggregation module) based on cookie type. Other steps in the method shown in FIG. 3 are similar to those in FIG. 2, such as:

First step 12 of FIG. 3, intercepting incoming tracking data sets and depositing the tracking data sets (cookies) in a data aggregation module (cookie jar).

Step 14 of FIG. 3, which is the step of creating an aggregated data set (super-cookie) in which all data of other tracking data sets is aggregated.

Step 16 of FIG. 3, which is the step of allowing a user to specify data in the aggregated data set that is authorized to be shared upon a data request from a website.

Step 32 of FIG. 3, in which a first value is created based on the percentage of the user data is allowed to be shared by the user.

Step 34 of FIG. 3, which is the step of creating a second value based on the number of cookies that have been collected.

Step 36 of FIG. 3, which is the step of creating a quality score based on the previously created first value and second value.

Step 20 of FIG. 3 shows the step of intercepting tracking data requests.

Step 22 of FIG. 3, which shows the step of determining the source of the tracking data request.

Step 24 of FIG. 3, the step of submitting a request for a bid occurs.

Step 26 of FIG. 3, which shows the step of receiving bids at the bidding exchange server from ad exchange networks.

Step 28 of FIG. 3, which shows the step of the bidding exchange server providing the winning ad network with the selected aggregated data set data of the user, in exchange for an amount bid, which is shown at Box 30 of FIG. 3.

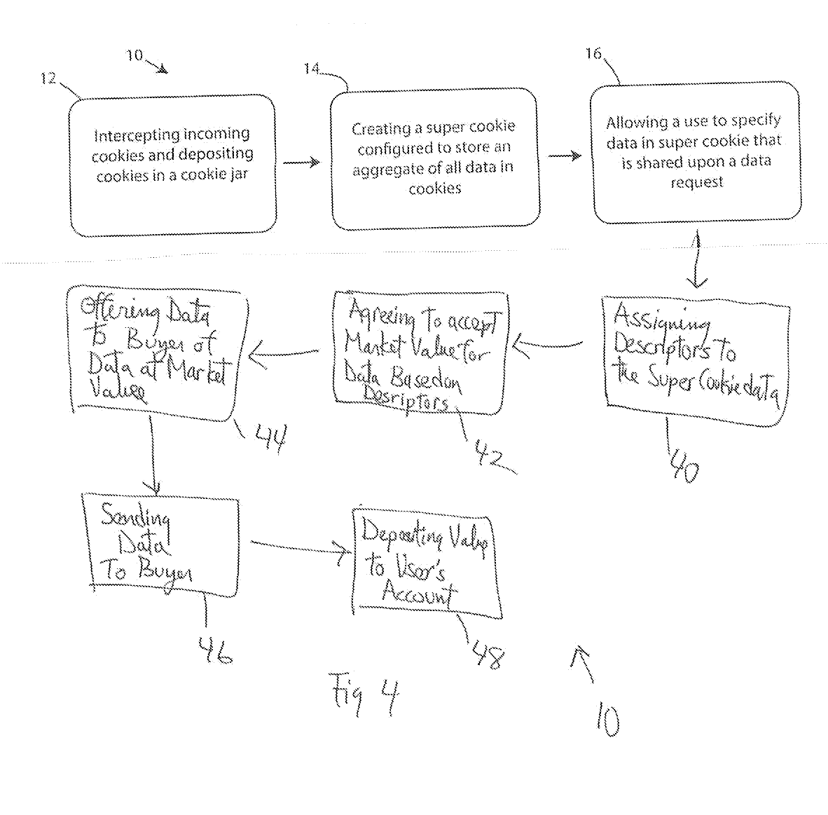

FIG. 4 is a flow diagram of a version of the claimed method in which steps 12, 14, and 16 are repeated. After the user specifies which types of data are to be shared, in Step 16, the next step is assigning descriptors to the data to be offered, in step 40. The descriptors can such terms as low, medium, high, or words such as income $50-$75, age 20-30, female, jewelry buyer, shopping for Caribbean Cruise, or other demographic descriptors relevant to advertisers. Knowing this kind of specific information could be very useful to advertisers, and would increase the value of the data being offered. It would allow advertisers to only buy data that is specific to their products and services, and pass over other, non-useful data.

At step 42, which can be accomplished in a different order, the user agrees to accept a market value calculated price for the data being offered, with the market value based on the descriptors for the data. The market value calculated price can be determined by procedures not controlled by the user or by the buyer, but by a history of past sales of data. Step 44 is the step of offering the selected data to buyers at the calculated market value price for data with the assigned descriptors. This step is followed by the step of a buyer offering to pay market value for the offered data.

The next step is similar as the other embodiments of the claimed method, which is step 46, sending the purchased data to one or more users, followed by step 48, which is delivering value to a user's account. “Value” can be currency, such as to a bank account. It can also be adding value to a digital account, such as Paypal, or by adding credit to a purchasing account, such as bitcoin, Amazon, Ebay, VISA, a brokerage account, or other entities which handle transactions for value.

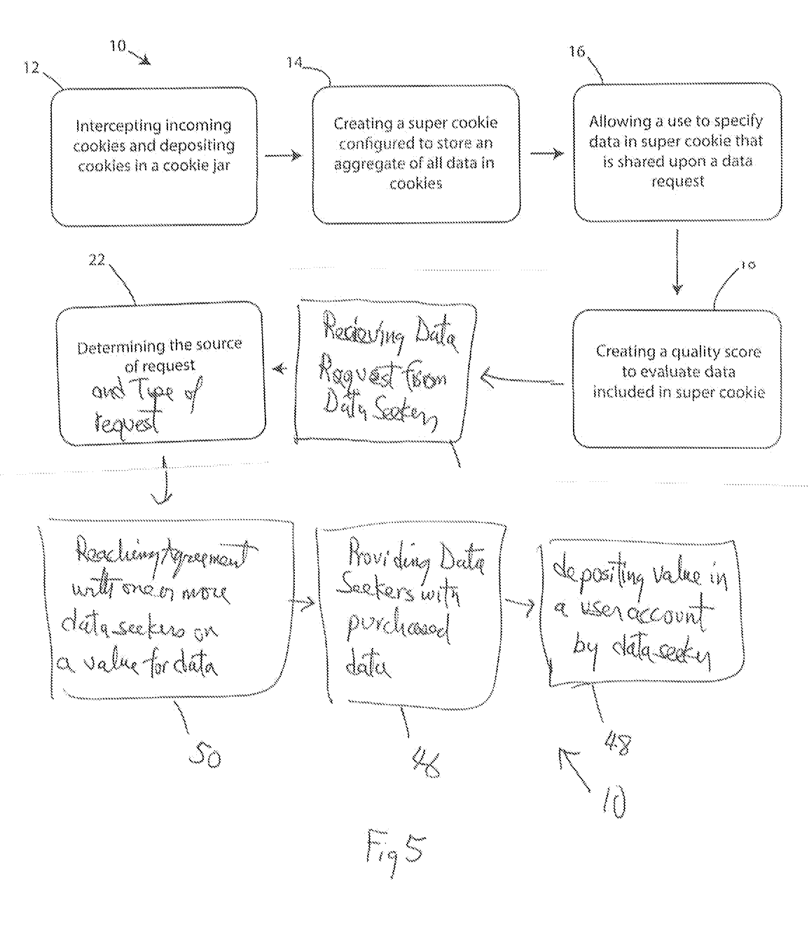

FIG. 5 is a flow diagram of a version of the claimed method in which steps 12, 14, 16, 22, and 18 are repeated. After the quality score is created for the data to be sold, the step 52, receiving data request from data seekers occurs. The next step is the same as other embodiments, where at step 22 the source and type of request is determined. The next step is step 50, which is reaching agreement with one or more data seekers on a value for data. If the sale is exclusive, and thus to only one buyer, the price could be higher. If the sale is non-exclusive, many buyers can buy the same information and the data would be less useful. An intermediate level of exclusivity can be where a set number of buyers, such as 10, are offered the data set. In this arrangement the data would be less valuable than an exclusive sale, but more valuable than a non-exclusive sale.

The next step shown in FIG. 5 is step 46, providing the purchased data to the successful data seekers, followed by step 48, depositing value into an account of the user.

I claim:

1. A method of managing personal browsing data on a user's computer, comprising the steps of:
intercepting incoming tracking data sets and depositing said tracking data sets in a data aggregation module;
creating a aggregated data set configured to store an aggregate of all data in said tracking data sets;
specifying data in said aggregated data set that is to be shared upon a data request;
creating a quality score to rate data included in said aggregated data set;
receiving data requests from data seekers;
determining the source and type of said data request;
reaching agreement with said data seekers on a value for said aggregated data set;
providing selected data seekers with aggregated data set data; and
allowing data seekers to deposit an agreed upon value into a linked user account.

2. The method of managing personal browsing data of claim 1 which further comprises the step of said user assigning a “buy it now” value to said aggregated data set.

3. The method of managing personal browsing data of claim 1 which further comprises the step of said user designating said aggregated data set to be available at a market value as determined by said quality score.

4. The method of managing personal browsing data of claim 1 which further comprises the step of said user and said data seekers using a bidding exchange server in which data seekers bid on aggregated data sets of certain quality scores and purchase said data sets and deposit value to a user account.

5. The method of managing personal browsing data of claim 1 which further comprises the step of said user's data being rated using agreed upon descriptors, with said user accepting a market value for data packets with that combination of descriptors.

6. A method of managing personal browsing data on a user's computer, comprising the steps of:
intercepting incoming tracking data sets and depositing said tracking data sets in a data aggregation module;
creating a aggregated data set configured to store an aggregate of all data in said tracking data sets;
specifying data in said aggregated data set that is to be shared upon a data request;
creating a quality score to rate data included in said aggregated data set;
receiving cookie data requests from data seekers;
determining the source and type of said data request;
submitting a request for bid to a bidding exchange server for requests for data from data seekers;
receiving bids at said bidding exchange server from one or more ad exchange networks;
selecting a winning bid for data from said aggregated data set with said bidding exchange server providing winning ad network with aggregated data set data; and
depositing the winning bid value into a linked user account.

7. The method of claim 6 wherein the step of creating a quality score further comprises the steps of:
creating a first value based on the percent of user data being shared by a user;
creating a second value based on the number of tracking data sets that have been collected into the data aggregation module;
creating a quality score based on said first value and said second value.

8. The method of claim 6 wherein the step of submitting a bid to the bidding exchange server further comprises the steps of:
submitting said quality score;
submitting the type of information available in said aggregated data set.

9. The method of claim 6 wherein the step of intercepting incoming tracking data sets further comprises the step of:
placing the tracking data into a category based on tracking data type.

10. A system for managing personal data comprising:
a. A tracking data and data aggregation module, for intercepting incoming tracking data requests, depositing new tracking data sets in a data aggregation module, compiling tracking data information into a aggregated data set, assigning a Quality Score to said aggregated data set, analyzing data available, and sending said quality score and said data availability analysis to a bidding exchange server;
b. A data selection module, for allowing user selection of sharable data;
c. A bidding exchange server capable of receiving said quality score and said data availability analysis, receiving bids from third parties, determining winning bid, receiving bid money from bidder, delivering user data to the winning bidder, and depositing money into a user specified account.

11. The system for managing personal data of claim 10 wherein said Quality Score is a score from 0 to 100 and is based upon the amount of data made available by the user, and the number of tracking data sets that have been collected in the data aggregation module.

12. The system for managing personal data of claim 10 wherein said tracking data and data aggregation module is configured to operate within an internet browser environment.

13. The system for managing personal data of claim 10 wherein said tracking data and data aggregation module is configured to operate within a mobile device.

14. The system for managing personal data of claim 10 wherein said data selection module is configured to operate within an internet browser environment.

15. The system for managing personal data of claim 10 wherein said bidding exchange server is configured to operate at a remote location.
